(19) United States
(12) Patent Application Publication
(10) Pub. No.: US 2019/0164656 A1
(43) Pub. Date: May 30, 2019

(54) HIGH-TEMPERATURE NUCLEAR REACTOR COOLED WITH MOLTEN FLUORIDE SALT

(71) Applicant: CENTRUM VYZKUMU REZ, S.R.O., Husinec - Rez (CZ)

(72) Inventors: Marek RUSCAK, Prague (CZ); Evzen LOSA, Brno (CZ); Davit HARUTYUNYAN, Prague (CZ); Pavel DOSTAL, Prague (CZ)

(21) Appl. No.: 15/891,963

(22) Filed: Feb. 8, 2018

(30) Foreign Application Priority Data
Nov. 29, 2017 (CZ) CZ 2017-765

(51) Int. Cl. G21C 15/28; G21C 15/243; G21C 5/12; C09K 5/12

(52) U.S. Cl. CPC G21C 15/28; C09K 5/12; G21C 5/123; G21C 15/243

(57) ABSTRACT

The technical solution relates to a fluoride salt-cooled high-temperature nuclear reactor with low output.

### CROSS-REFERENCE TO RELATED APPLICATIONS

This application claims priority to Czech Republic patent application Ser. No. CZ 2017-765 filed Nov. 29, 2017, which is incorporated herein by reference in its entirety.

### TECHNICAL FIELDS

The technical solution relates to a fluoride salt-cooled high-temperature nuclear reactor with low output.

### BACKGROUND ARTS

The development of reactors that use molten fluoride salts during their operation dates back to the 1960s. In the first concepts of fluoride reactors, liquid fuel (MSR) was considered, but this carries a very complex solution to the chemical processes used to purify fluoride salts from fuel fission products. For this reason, it was later dropped from the development of this type of reactor. The advantage of the use of molten fluoride salt based coolant is the transfer of high-potential heat, which can be used both for the production of high efficiency electricity, and for direct use in industrial processes (chemical, metallurgical, hydrogen production for energy purposes).

In 2004, the pre-conceptual design of the reactor (AHTR [1]) using fluoride salt in combination with solid fuel was published. This proposal was to be an alternative to a helium-cooled high temperature reactor and, to a certain extent, was based on MSR reactors. The AHTR reactor is conceived as a classic large nuclear power plant with an electrical output of approximately 1300 MW. The considered salt temperature when exiting from the core is within the range 700 to 1000° C.

The lower power reactor design (SmAHTR [2]) appeared in 2010. The technical solution is to a large extent common to the AHTR reactor, but in the case of a smaller reactor, more emphasis is placed on the compactness and modularity of the system. Even in the case of SMAHTR reactors, their use will be similar to conventional nuclear power plants. The coolant temperature when exiting from the core is 700° C. The design of the zone and fuel will be based on the concept AHTR.

A common feature of the two types of reactors described above is the need to define a large protected area and the use of a considerable amount of additional infrastructure, especially for the exchange and storage of fuel, which makes it possible to operate these reactors.

The concept of this technical solution was drawn from the following literature:
[1]. Status of Preconceptual Design of the Advanced High-Temperature Reactor. ORNL/TM-2004/104, available from https://info.ornl.gov/sites/publications/Files/Pub57278.pdf, Oct. 6, 2017,
[2]. Greene, S. R. et al., “Pre-Conceptual Design of a Fluoride-Salt-Cooled Small Modular Advanced High-Temperature Reactor (SmAHTR)”, ORNL/TM-2010/199, 2010, available from http://info.ornl.gov/sites/publications/files/Pub26178.pdf, Sep. 20, 2017.

### DISCLOSURE OF INVENTION

The above mentioned drawbacks are removed by a high temperature nuclear reactor cooled by molten fluoride salt disposed in a reactor vessel, the active zone of which consists of prismatic fuel assemblies, and is surrounded by a reflector, the fuel remaining in the active zone throughout the life of the reactor module, the container forms a transport container for transporting fresh or spent fuel, and which is provided with a cooling system. The cooling system consists of a mixing chamber provided with a riser, surrounding the heat exchanger, to remove residual heat from the reactor core through natural coolant circulation. The cooling system is equipped with a pump.

The proposed technical solution eliminates construction requirements, and can be used in areas where there is no developed infrastructure.

The active zone consists of a fixed prismatic fuel system, the reactor vessel also serves as a packaging container for the transport of the radioactive inventory, and the fuel supply in the active zone is sufficient for the total period of the reactor operation. The reactor active zone consists of a semi-homogeneous prismatic fuel assembly located in the reactor grid, and surrounded by a reflector. The fuel remains in the active zone for the lifetime of the reactor module. The fuel construction allows for the use of advanced cycles, based on the use of thorium or plutonium isotopes.

The reactor according to this technical solution serves as a source of energy and heat for technological units, or for populated areas cut off from the power grid and sufficient infrastructure. Reactor power is limited to 20 MW thermal, with an expected service life of more than 6 years. The basic philosophy of the concept is the replacement of diesel aggregates in the locations and applications where they are used. The specificity of the reactor is coolant in the form of a eutectic mixture of LiF—BeF2 molten fluoride (66-34%), a fuel typical of high temperature, gas cooled reactors (HTGR), and a graphite moderator.

The reactor according to this technical solution is, in contrast to the above-mentioned concepts, capable of being placed in locations with insufficiently developed infrastructure, because the body of the active zone with the exchanger will be stored in a container which will meet the requirements for the transport packaging container. This means that there is no need to handle spent nuclear fuel on site in any way. At the end of the fuel life, the module with the active zone will be disconnected and left in place (approx. 5 years) until the residual heat falls, and the dose rate on the surface of the container will drop to a value allowing for return to the factory.

### BRIEF DESCRIPTION OF DRAWINGS

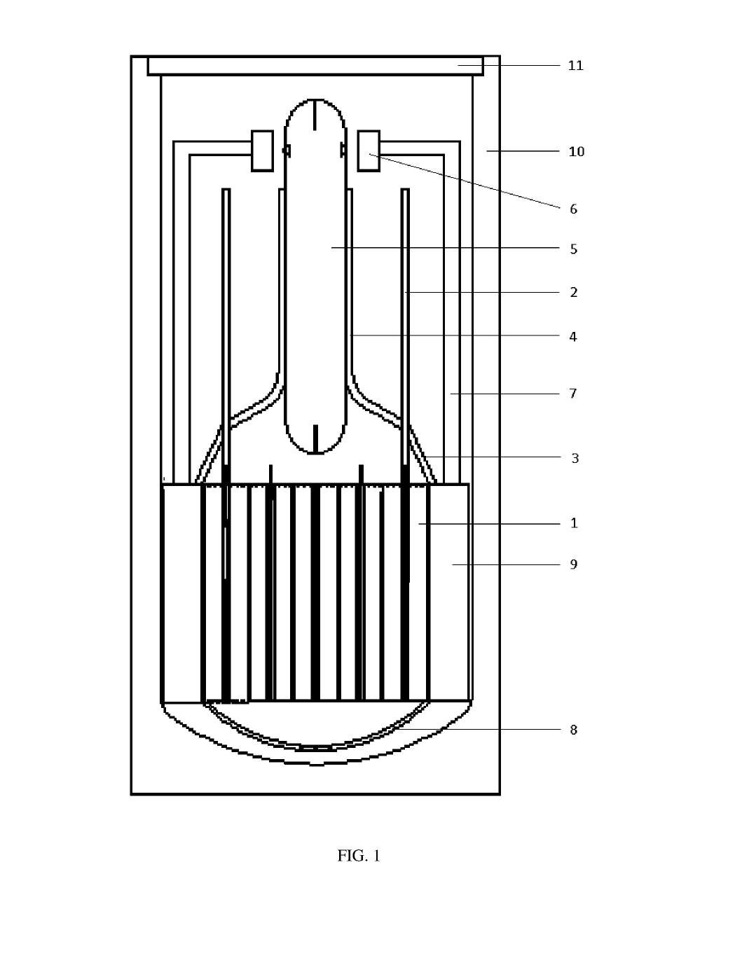

The technical solution will be further clarified by means of drawings, where FIG. 1 shows a longitudinal cross section of the reactor.

### MADE FOR CARRYING OUT THE INVENTION

The fuel assemblies 1 are fed into the active zone grid. Reactivity is controlled by the absorption rods. The heat generated by the fission of the fuel material is withdrawn with the fluoride salt in the fuel assemblies 1 and between the fuel assemblies 1. The salt flow direction is from the lower part of the active zone to the upper part. The coolant in the upper part leaves the fuel, and blends in the upper mixing chamber 3. The absorption rods 2 pass through the upper mixing chamber 3. From the upper mixing chamber 3, the coolant flows through the riser 4 to the exchanger 5 in which the secondary medium circulates. After passing through the exchanger 5, the coolant is pumped by the pumps 6 through the gravity channels 7 to the lower part of the reactor, where the lower mixing chamber 8 is located. In the lower mixing chamber 8, the coolant is mixed and the fuel passes through again 1. The reactor active zone is surrounded by the reflector 9. The entire primary circuit, including the exchanger 5 and other auxiliary systems, is located in the reactor vessel 10, which also serves as a transport container for both fresh and spent fuel. The reactor vessel 10 is made of cast iron, and is provided with a lid 11 of the same material. The lid 11 is attached to the reactor vessel 10 by means of screws. Because the reactor requires little supervision, and therefore it is not envisaged in the design that it will be necessary to dismantle the cover 11 after the start up or during the operation of the reactor for maintenance and inspection purposes.

### INDUSTRIAL APPLICATION OF THE INVENTION

The reactor according to this technical solution serves as a source of energy and heat for technological units, or populated areas cut off from the power grid and sufficient infrastructure. At the same time, it can use advanced fuel cycles, including the thorium cycle or the combustion of plutonium or minor actinoids.

What is claimed is:

1. A high-temperature nuclear reactor cooled by molten fluoride salt located in a reactor vessel (10), the active zone of which consists of prismatic fuel assemblies (1) and is surrounded by a reflector (9), the fuel remaining in the active zone throughout the life of the reactor module is characterized in that the reactor vessel (10) forms a transport container for transporting fresh or spent fuel which is provided with a cooling system.

2. A high-temperature nuclear reactor cooled by molten fluoride salt, according to claim 1, is characterized in that the cooling system is formed by a mixing chamber (3) provided with a riser (4) surrounding the exchanger (5), to extract the residual heat from the active zone by natural refrigerant circulation.

3. A high-temperature nuclear reactor cooled by molten fluoride salt, according to claims 1 and 2, is characterized in that the cooling system is provided with a pump (6).
